(19) United States
(12) Patent Application Publication
(10) Pub. No.: US 2003/0154384 A1
(43) Pub. Date: Aug. 14, 2003

(54) Method and arrangement for the manufacture of mask-programmed ROMs while utilizing a mask comprising a plurality of systems, as well as a corresponding computer program product and a corresponding computer-readable storage medium

(76) Inventor: Detlef Mueller, Barsbuettel (DE)

Correspondence Address: PHILIPS ELECTRONICS NORTH AMERICAN CORP, 580 WHITE PLAINS RD, TARRYTOWN, NY, 10591, US

(21) Appl. No.: 10/320,272

(22) Filed: Dec. 16, 2002

(30) Foreign Application Priority Data
Dec. 19, 2001 (DE) 10162307.0

(51) Int. Cl. G06F 12/14

(52) U.S. Cl. 713/189

(57) ABSTRACT

The invention relates to a method and an arrangement for the manufacture of mask-programmed ROMs while utilizing a mask comprising a plurality of systems, as well as to a corresponding computer program product and to a corresponding computer-readable storage medium which can be used notably for optimizing the protection against attacks by hackers by individualizing the ROM code masks during the manufacture of ROMs with security-relevant data.

In order to provide protection against unauthorized reading, encryption is carried out in smart card controllers. Optimum protection is obtained when different keys are used for each chip, because all other devices will still be protected should one device be successfully decrypted.

During the production process a plurality of systems is simultaneously present on a physical mask. Thus far all systems on the physical ROM mask contain the same ROM code and the same key. When an individual key is calculated for each individual system during the manufacture of the ROM mask, products are obtained for which different keys exist despite the same (logic) ROM code, thus enhancing the effectiveness of the protection of the ROM encryption.

The invention relates to a method and an arrangement for the manufacture of mask-programmed ROMs while utilizing a mask comprising a plurality of systems, as well as to a corresponding computer program product and a corresponding computer-readable storage medium which can be used notably for optimizing the protection against the discovery of secret information by individualizing the ROM code masks during the manufacture of ROMs with security-relevant data. Because smart cards serve as memories for such security-relevant information, they constitute a special field of application of the invention.

The evolution of microelectronics in the seventies has led to the manufacture of small computers having the format of a credit card without a user interface. Computers of this kind are referred to as smart cards. In such a smart card a data memory and an arithmetic and logic unit are integrated in a single chip which is no larger than a few square millimeters. Smart cards are used notably as telephone cards, GSM-SIM cards, in the field of banking and in the field of health care. The smart card has thus become an omnipresent arithmetic means.

Nowadays smart cards are used mainly as a secure store for secret data and as a secure execution means for cryptographic algorithms. The assumption of a comparatively high degree of security of the data and algorithms on the card is based on the hardware construction of the card and the interfaces to the environment. To the environment the card represents a “black box” whose functionality can be accessed only via a well-defined hardware and software interface and which is capable of imposing specific security policies. On the one hand, the access to data can be made subject to given conditions. Critical data such as, for example, secret keys of a Public Key method, can even be completely excluded from access from the outside. On the other hand, a smart card is capable of carrying out algorithms without it being possible to observe the individual operations from the outside. The algorithms themselves can be protected against modification and reading out on the card. In an object-oriented sense, the smart card can be considered as an abstract encapsulated type which comprises a well-defined interface, exhibits a specified behavior and is itself capable of ensuring that given integrity conditions in relation to its state are satisfied.

In principle there are two different types of smart cards. Memory cards comprise merely a serial interface, an addressing and security logic circuit and ROM and EEPROM memories. These cards have a limited functionality only and serve a specific purpose. Therefore, their manufacture is very inexpensive. Smart cards manufactured as microprocessor cards in principle constitute a complete universal computer.

The following phases can be distinguished in the process of manufacture and delivery of chip cards:

manufacturing the semiconductor,

encapsulating the semiconductor,

printing the card,

personalizing the card,

issuing the card.

Generally speaking, each phase is carried out by a company that is specialized in the relevant field. During the manufacture of the semiconductors a high degree of security has to be ensured within the relevant company, that is, notably for cards provided with a wired security logic circuit. In order to enable the manufacturer to perform a correct final test, the complete memory must be freely accessible. The chip is secured by a transport code only after completion of the final test. After that the card memory can be accessed only by authorized agencies that know the transport code. Theft of semiconductors fresh from the factory, therefore, remains without consequences. Authorized agencies may be personalizers or issuers of cards. The encapsulation and printing do not require further security functions. The companies concerned need not know the transport code.

Generally speaking, the transfer of the person-specific data to the card is not carried out by the manufacturer but by the agency issuing the card (for example, a bank, a telephone company, a health insurance company etc.). This procedure is referred to as personalization. In order to carry out this procedure it is necessary to know the transport code.

The actual issuing of the card, that is, the transport from the agency issuing the card to the cardholder poses a further security problem. Strictly speaking, the only secure way is to hand over the card to the card holder in person who signs for receipt after having shown proof of identity. Distribution by mail is often more economical, but also rather unsafe. A problem is posed also by the transfer of the PIN to the cardholder; the same care must then be taken as for the issuing of the card itself.

Because of the crucial, security-relevant contents of the memories accommodated on smart card controllers, it does suffice to take only the aforementioned security measures; additional protection must be provided against any attacks by hackers which may be aimed at all phases of the service life of a smart card, that is, beginning with the manufacture and then the transport and the use of the card as well as manipulation of cards which have become useless.

In the past numerous attempts have already been made to mitigate the security problems which occur notably in the case of smart cards and are due to unauthorized access to the security-relevant memory contents.

U.S. Pat. No. 5,199,159 discloses a secure memory having multiple security levels. The secure memory comprises a first security zone which can be accessed only in a code-protected fashion; a control device then checks whether access is attempted with invalid codes and inhibits access after a specified number of invalid attempts. Further function units included in the secure memory are protected in the same way. It has been found that the security of the relevant memory can be enhanced by taking these multiple security measures.

A further method of preventing the unauthorized access to data is disclosed in U.S. Pat. No. 6,094,724. This document describes two security aspects: first of all, encryption is used to provide authentication of both the smart card and the smart card reader; secondly, the access to the various function units of the smart card takes place individually with respective different encryptions or passwords.

Depending on the chip size, a plurality of systems is always simultaneously present on a physical mask during the production process of smart card controllers. For customary smart card controllers these systems amount to from approximately 30 to 50 . All systems on the physical ROM mask nowadays contain the same ROM code and the same key. A customary method is to keep the codes or keys in ROM fuses (special ROM cells). Different keys can thus be realized for each ROM code. However, all devices with one ROM code have always the same key.

In contemporary smart card controllers a key is formed for each ROM code. This key is the same for all devices having this ROM code. This drawback is not eliminated either by the cited documents U.S. Pat. No. 5,991,519 and U.S. Pat. No. 6,094,724. The systems formed by means of a mask still have the same key when the methods proposed therein are carried out.

It is an object of the invention to provide a method, an arrangement and a corresponding computer program product as well as a corresponding computer-readable storage medium of the kind set forth which eliminate the described drawbacks and offer additional protection of mask-programmed ROMs manufactured while utilizing masks comprising a plurality of systems.

In accordance with the invention this object is achieved as disclosed in the characterizing part of the claims 1, 5, 6 and 7 in conjunction with the features disclosed in the introductory part. Effective embodiments of the invention are disclosed in the dependent claims.

A special advantage of the invention resides in the fact that during the manufacturing process for mask-programmed ROMs while utilizing a mask comprising several systems the systems formed by means of the mask are encrypted in such a manner that the encryption is performed with different keys for at least two of the systems formed by means of the mask.

An arrangement for the manufacture of mask -programmed ROMs while utilizing a mask comprising a plurality of systems preferably includes a processor which is arranged in such a manner that mask programmable ROMs can be formed while utilizing a mask comprising a plurality of systems in that the systems formed by means of the mask are encrypted in such a manner that the encryption is performed with different keys for at least two of these systems.

A computer program product for the manufacture of mask-programmed ROMs while utilizing a mask comprising a plurality of systems preferably includes a computer-readable storage medium on which a program is stored which, after having been loaded into the memory of a computer, enables the computer to carry out the manufacture of mask-programmable ROMs while utilizing a mask comprising a plurality of systems in that the systems formed by means of the mask are encrypted in such a manner that the encryption is performed with different keys for at least two of these systems.

A computer-readable storage medium in accordance with the invention for the manufacture of mask-programmed ROMs while utilizing a mask comprising a plurality of systems preferably stores a program which, after having been loaded into the memory of a computer, enables the computer to carry out the manufacture of mask-programmable ROMs while utilizing a mask comprising a plurality of systems in that the systems formed by means of the mask are encrypted in such a manner that the encryption is performed with different keys for at least two of these systems.

In a preferred embodiment of the invention it is arranged that a respective individual key is calculated for all systems formed by means of the same mask.

In a further preferred embodiment of the invention it is arranged that the keys are contained in ROM fuses.

Furthermore, it has been found that the encryption is advantageously carried out for addresses and/or data.

An embodiment of the invention will be described in detail hereinafter by way of a non-limitative example.

Encryption of addresses and data is carried out in smart card controllers (SCC) for all types of memory (RAM, non-volatile memory, ROM) in order to protect memory contents against unauthorized reading out by an unauthorized person. Optimum protection is achieved inter alia when different keys are used for each chip, because in that case all other devices are still protected against attacks (for example, deliberate code manipulations) even in the event of successful decryption of one device.

As stated before, in dependence on the chip size a plurality of systems is always simultaneously present on a physical mask during the production process. All systems on the physical ROM mask (nowadays from 30 to 50 systems) are thus given the same ROM code and the same key. When an individual key is calculated for each individual system during the manufacture of the ROM mask (and hence also an individual physical ROM code), the production will yield products for which approximately from 30 to 50 different keys exist despite the same (logic) ROM code. Granted, this means a given higher expenditure for the formation of the ROM masks, but this additional expenditure is justified since carrying out the method in accordance with the invention significantly enhances the effectiveness of the protection of the ROM encryption. The individualization of the ROM code masks thus obtained in the manufacture of smart card controllers yields approximately from 30 to 50 different keys for the same (physical) ROM code. This results in a substantially enhanced effectiveness of the protection against attacks such as, for example, the discovery of secret information or abusive code manipulations.

The invention is not limited to the embodiments described herein. To the contrary, without departing from the scope of the invention further embodiments can be realized by combination and modification of the described means and features.

1. A method for the manufacture of mask-programmed ROMs while utilizing a mask comprising a plurality of systems, characterized in that the systems formed by means of the mask are encrypted in such a manner that the encryption is performed with different keys for at least two of the systems formed by means of the mask.

2. A method as claimed in claim 1, characterized in that a respective individual key is calculated for all systems formed by means of the same mask.

3. A method as claimed in one of the preceding claims, characterized in that the keys are contained in ROM fuses.

4. A method as claimed in one of the preceding claims, characterized in that the encryption is carried out for addresses and/or data.

5. An arrangement which includes a processor which is arranged in such a manner that mask-programmable ROMs can be formed while utilizing a mask comprising a plurality of systems in that the systems formed by means of the mask are encrypted in such a manner that the encryption is performed with different keys for at least two of these systems.

6. A computer program product which includes a computer-readable storage medium on which a program is stored which, after having been loaded into the memory of a computer, enables the computer to carry out the manufacture of mask-programmable ROMs while utilizing a mask comprising a plurality of systems in that the systems formed by means of the mask are encrypted in such a manner that the encryption is performed with different keys for at least two of these systems.

7. A computer-readable storage medium which stores a program which, after having been loaded into the memory of a computer, enables the computer to carry out the manufacture of mask programmable ROMs while utilizing a mask comprising a plurality of systems in that the systems formed by the means of the mask are encrypted in such a manner that the encryption is performed with different keys for at least two of these systems.
